(19) United States
(12) Patent Application Publication
(10) Pub. No.: US 2015/0349333 A1
(43) Pub. Date: Dec. 3, 2015

(54) COMPOSITE CATHODE ACTIVE MATERIALS, PREPARATION METHODS THEREOF, AND LITHIUM BATTERIES INCLUDING THE COMPOSITE CATHODE ACTIVE MATERIALS

(71) Applicant: Samsung Electronics Co., Ltd., Suwon-si (KR)

(72) Inventors: Junho Park, Seoul (KR); Wonsung Choi, Yongin-si (KR); Jaegu Yoon, Suwon-si (KR); Yoonsok Kang, Seongnam-si (KR); Jinhwan Park, Seoul (KR); Sungjin Ahn, Anyang-si (KR); Jaejun Chang, Seoul (KR); Byungjin Choi, Seoul (KR)

(21) Appl. No.: 14/602,358

(22) Filed: Jan. 22, 2015

(30) Foreign Application Priority Data
May 30, 2014 (KR) 10-2014-0066522

(51) Int. Cl. H01M 4/36; H01M 10/0525; H01M 4/587; H01M 4/525; H01M 4/133; H01M 4/485; H01M 4/505; H01M 4/62; H01M 4/131

(52) U.S. Cl. CPC H01M 4/366; H01M 4/62; H01M 10/0525; H01M 4/587; H01M 4/131; H01M 4/133; H01M 4/485; H01M 4/505; H01M 4/525; H01M 2004/028

(57) ABSTRACT

A composite cathode active material including: a core including an active material; and a coating film disposed on a surface of the core, the coating film including a carbon nanostructure; and a first polymer, wherein the first polymer is at least one selected from i) a fully fluorinated polymer and ii) a partially fluorinated polymer having a fluorine content of about 60 atomic percent to about 90 atomic percent, based on a total content of the partially fluorinated polymer.

### RELATED APPLICATION

This application claims priority to and the benefit of Korean Patent Application No. 10-2014-0066522, filed on May 30, 2014, in the Korean Intellectual Property Office, and all the benefits accruing therefrom under 35 U.S.C. §119, the content of which is incorporated herein in its entirety by reference.

### BACKGROUND

1. Field

The present disclosure relates to a composite cathode active material, preparation methods thereof, and a lithium battery including the composite cathode active material.

2. Description of the Related Art

Miniaturized lightweight lithium batteries having high energy density are desired for miniaturization and high performance conversion of various devices.

In order to provide miniaturized high-performance lithium batteries, studies have actively been made on the development of cathode active materials which have high voltage and provide excellent high-rate and lifetime characteristics.

Previous high voltage cathode active materials cause side reactions with an electrolyte during the charge/discharge process, and produce by-products such as transition metals and gases eluted from the cathode active materials. Performance characteristics, such as high-rate characteristics and lifetime characteristics, of batteries are deteriorated by the side reactions of the cathode active materials and the by-products produced from the cathode active materials. Therefore, there remains a need for high-voltage cathode active materials with improved lifetime and high rate characteristics.

### SUMMARY

Provided is a composite cathode active material and preparation methods of the composite cathode active material.

Provided is a lithium battery including the composite cathode active material.

Additional aspects will be set forth in part in the description which follows and, in part, will be apparent from the description.

According to an aspect, a composite cathode active material includes: a core including an active material; and a coating film disposed on a surface of the core, the coating film including a carbon nanostructure; and a first polymer, wherein the first polymer is at least one selected from i) a fully fluorinated polymer and ii) a partially fluorinated polymer having a fluorine content of about 60 atomic percent to about 90 atomic percent, based on a total content of the partially fluorinated polymer.

According to another aspect, disclosed is a method of preparing the composite cathode active material, the method including: forming a coating film on a surface of a core including an active material, wherein the coating film includes a carbon nanostructure, and a first polymer, wherein the first polymer is at least one selected from i) a fully fluorinated polymer and ii) a partially fluorinated polymer having a fluorine content of about 60 atomic percent to about 90 atomic percent, based on a total content of the partially fluorinated polymer.

According to another aspect, a cathode includes the cathode active material.

According to another aspect, a lithium battery includes the cathode.

### BRIEF DESCRIPTION OF THE DRAWINGS

These and/or other aspects will become apparent and more readily appreciated from the following description of the embodiments, taken in conjunction with the accompanying drawings in which:

FIG. 1A is a drawing showing the structure of an embodiment of a composite cathode active material;

FIG. 1B is a drawing showing the structure of another embodiment of a composite cathode active material;

FIG. 2 is an exploded perspective view of an embodiment of a lithium battery;

FIG. 3A, FIG. 4A, FIG. 5A, and FIG. 6A show scanning electron microscope (“SEM”) images of a composite cathode active material according to Preparation Example 1 and cathode active materials according to Comparative Examples 1 to 3, respectively;

FIG. 3B, FIG. 4B, FIG. 5B, and FIG. 6B are SEM images obtained by expanding the images of FIG. 3A, FIG. 4A, FIG. 5A, and FIG. 6A to provide a greater magnification;

FIG. 7 is a SEM image of polytetrafluoroethylene (“PTFE”);

FIGS. 8A and 8B show scanning electron microscope-energy dispersive spectroscopy (“SEM-EDS”) analysis results of the composite cathode active material obtained according to Preparation Example 1;

FIGS. 9A and 9B show scanning electron microscope-focused ion beam analysis results of cross-section and surface of the composite cathode active material obtained according to Preparation Example 1;

FIG. 10 is a graph of weight loss (percent) versus temperature (° C.) which shows thermogravimetric analysis results for the cathode active materials of Comparative Preparation Examples 1 and 2 and the composite cathode active material of Preparation Example 1;

FIG. 11 is a graph of intensity (counts per second) versus binding energy (electron volts, eV) which shows X-ray Photoelectron Spectroscopy (“XPS”) analysis results for the composite cathode active material of Preparation Example 1 and the cathode active materials of Comparative Preparation Examples 1 to 3;

FIG. 12 is a graph of capacity retention ratio (percent) versus cycle number which shows capacity retention rate changes for coin cells manufactured according to Example 1 and Comparative Examples 1 to 4;

FIG. 13 is a graph of specific capacity (milliampere-hours per gram (mAh/g)) versus cycle number which shows specific capacity properties of the coin cells manufactured according to Example 1 and Comparative Examples 1 to 4;

FIG. 14 is a graph of load (grams-force her centimeter, gf/cm) versus extension length (millimeters, mm) which shows T-peel test results for cathodes obtained according to Example 1 and Comparative Example 1; and

FIG. 15 is a graph of specific capacity (milliampere-hours per gram, mAh/g) versus cycle number which shows specific capacity properties of the coin cells manufactured according to Examples 1 and 2 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. “Or” means “and/or.”

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers and/or sections, these elements, components, regions, layers and/or sections should not be limited by these terms. These terms are only used to distinguish one element, component, region, layer, or section from another element, component, region, layer, or section. Thus, “a first element,” “component,” “region,” “layer,” or “section,” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkyl” as used herein means a straight or branched chain, saturated, monovalent hydrocarbon group (e.g., methyl or hexyl).

“Alkoxy” means an alkyl group that is linked via an oxygen (i.e., alkyl-O—), for example methoxy, ethoxy, and sec-butyloxy groups. “Transition metal” as defined herein refers to an element of Groups 3 to 11 of the Periodic Table of the Elements.

“Rare earth” means the fifteen lanthanide elements, i.e., atomic numbers 57 to 71, plus scandium and yttrium.

The “lanthanide elements” means the chemical elements with atomic numbers 57 to 71.

Hereinafter, a composite cathode active material according to an embodiment, a lithium battery including the composite cathode active material, and a preparation method of the composite cathode active material will be disclosed in further detail.

Provided is a composite cathode active material comprising a core comprising an active material; and a coating film disposed on a surface of the core, the coating film comprising a carbon nanostructure; and a first polymer, wherein the first polymer is at least one selected from i) a fully fluorinated polymer and ii) a partially fluorinated polymer having a fluorine content of about 60 atomic percent to about 90 atomic percent, based on a total content of the partially fluorinated polymer. The coating film may be disposed on a top surface of the core.

The active material includes a material that can intercalate and deintercalate lithium.

The first polymer may be contained in an amount of about 10 parts by weight to about 700 parts by weight, e.g., about 20 parts by weight to about 500 parts by weight, or about 40 parts by weight to about 400 parts by weight, based on 100 parts by weight of the carbon nanostructure. When the first polymer is contained in the foregoing range, a lithium battery comprising the composite cathode active material may have improved lifetime characteristics and improved high-rate characteristics.

A combination of the first polymer and the carbon nanostructure may be contained in the coating film in an amount of about 0.1 part by weight to about 30 parts by weight, for example, about 0.1 part by weight to about 10 parts by weight, and for example about 0.5 part by weight to about 4 parts by weight, based on 100 parts by weight of the composite cathode active material. Here, when the combination of the first polymer and the carbon nanostructure are contained in the foregoing range, a lithium battery having improved lifetime characteristics and improved high-rate characteristics can be manufactured using the composite cathode active material.

The coating film is disposed on at least a portion of a surface of the core, e.g., on a top surface of the core. For instance, the coating film may be in the form of a continuous coating film, which is continuously formed on the entire surface of the core, or may be in the form of an island shape disposed on a portion of the surface of the core.

For instance, the fluorinated polymer may comprise a fully fluorinated polymer, which is a polymer in which all hydrogen atoms are substituted with fluorine, may comprise one or more selected from polytetrafluoroethylene (“PTFE”), perfluoroalkoxy polymer (“PFA”), and a poly(tetrafluoroethylene-hexafluoropropylene) copolymer (“FEP”). A representative partially fluorinated polymer is a polytetrafluoroethylene-perfluoroalkyl methacrylic copolymer.

The fluorinated polymer may comprise a fluorinated polymer or combination of polymers having a fluorine content of about 60 atomic % to about 90 atomic %, e.g., about 65 atomic % to about 80 atomic %, or about 67 atomic % to about 78 atomic %. When the fluorine is contained in the fluorinated polymer in the foregoing range, effects due to fluorine are superior.

Amounts of fluorine contained in the first polymer may be obtained by X-ray Photoelectron Spectroscopy (“XPS”), elemental Analysis (“EA”), thermogravimetric analysis (“TGA”), or scanning electron microscopy-energy dispersive spectroscopy (“SEM-EDS”). Since the first polymer may have a large binding energy, the first polymer may have improved chemical stability with respect to acid or alkali. Therefore, when a coating film comprising the first polymer is disposed on the surface of the core, a battery system having improved stability for a material, such as hydrogen fluoride (“HF”), which may be formed due to dissolution of an electrolyte, is provided. When a cathode comprising the composite cathode active material is used, a battery comprising the composite cathode active material may have improved lifetime characteristics.

According to an embodiment, a composite cathode active material may additionally include a second polymer in addition to the first polymer if desired, wherein examples of the polymer of the second polymer include one or more selected from polyvinylidene fluoride, polyimide, polyethylene, polyester, polyacrylonitrile, polymethylmethacrylate, polytetrafluoroethylene (“PTFE”), a carboxymethyl cellulose/styrene-butadiene rubber (“SMC/SBR”) copolymer, and a styrene butadiene rubber based polymer.

For instance, the second polymer may be contained in an amount of about 0.1 part by weight to about 20 parts by weight, e.g., about 1 part by weight to about 10 parts by weight, based on 100 parts by weight of the first polymer.

The composite cathode active material may have a solubility of about 0.1 milligrams per milliliter (mg/mL) or less, e.g., about 0.00001 mg/mL to about 0.1 mg/mL, or about 0.0001 mg/mL to about 0.01 mg/mL, with respect to an organic solvent. Also, the polymer contained in the coating film in the composite cathode active material may have a solubility of about 0.1 mg/mL or less, e.g., about 0.00001 mg/mL to about 0.1 mg/mL, or about 0.0001 mg/mL to about 0.01 mg/mL, with respect to the organic solvent.

The organic solvent may comprise at least one selected from a carbonate, an ester, an ether, a ketone, and an alcohol. The carbonate may be linear or cyclic, and may be fluorinated. Representative carbonates include at least one selected from diethyl carbonate (“DEC”), dimethyl carbonate (“DMC”), dipropyl carbonate (“DPC”), methyl propyl carbonate (“MPC”), ethyl propyl carbonate (“EPC”), methyl ethyl carbonate (“MEC”), or a combination thereof, and the cyclic carbonate compound may be, for example, ethylene carbonate (“EC”), propylene carbonate (“PC”), butylene carbonate (“BC”), vinyl ethylene carbonate (“VEC”), fluoroethylene carbonate (“FEC”), 4,5-difluoroethylene carbonate, 4,4-difluoroethylene carbonate, 4,4,5-trifluoroethylene carbonate, 4,4,5,5-tetrafluoroethylene carbonate, 4-fluoro-5-methylethylene carbonate, 4-fluoro-4-methylethylene carbonate, 4,5-difluoro-4-methyl ethylene carbonate, 4,4,5-trifluoro-5-methylethylene carbonate, and trifluoromethyl ethylene carbonate. Representative esters include at least one selected from methyl acetate, ethyl acetate, n-propyl acetate, dimethyl acetate, methyl propionate, ethyl propionate, γ-butyrolactone, decanolide, valerolactone, mevalonolactone, caprolactone, and methyl formate. Representative ethers include at least one selected from dibutyl ether, tetraglyme, diglyme, 1,2-dimethoxy ethane, 1,2-diethoxy ethane, ethoxy methoxy ethane, 2-methyl tetrahydrofuran, and tetrahydrofuran. A representative ketone is cyclohexanone. Representative alcohols include methanol, ethanol, isopropanol, and butanol. The solvent may comprise a nitrile, such as a C1 to C20 nitrile; an amide such as formamide or dimethyl formamide; a dioxolane such as 1,2-dioxolane or 1,3-dioxolane; a sulfolane such as dimethyl sulfoxide, sulfolane, or methyl sulfolane; 1,3-dimethyl-2-imidazolinone; N-methyl-2-pyrrolidinone; nitromethane; trimethyl phosphate; triethyl phosphate; trioctyl phosphate; or triester phosphate. The organic solvent N-methylpyrrolidone (“NMP”) is specifically mentioned.

Due to the excellent electrical conductivity of the carbon nanostructure, when a coating film including the carbon nanostructure is disposed on the surface of the core, a composite cathode active material that has improved rate capability can be provided. As is further described above, the coating film including the first polymer and the carbon nanostructure is disposed on the core, which comprises the active material. A lithium battery in which a cathode comprises the composite cathode active material may have improved rate characteristics and improved lifetime characteristics.

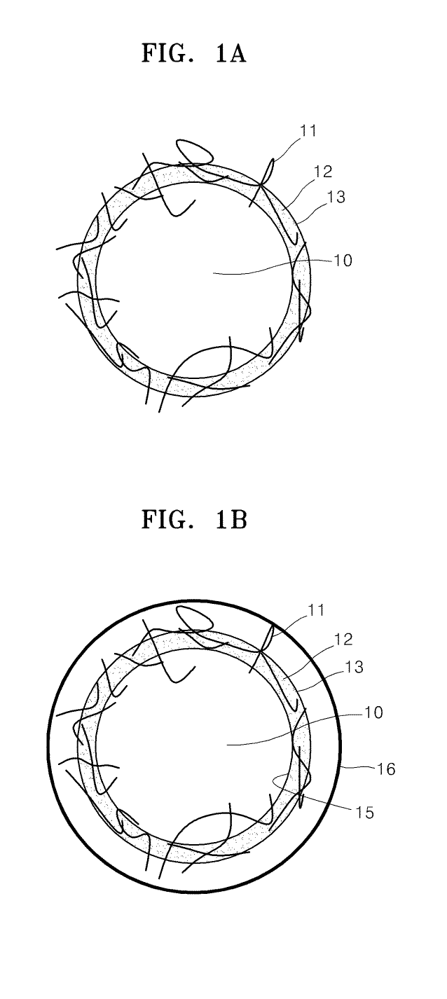

The coating film of the composite cathode active material may comprise a single film including the first polymer and the carbon nanostructure. The coating film may also be in the form of a multilayered film. For instance, as shown in FIG. 1B, the coating film may have a double layered structure including a first coating film 15, which is formed on a top surface of a core comprising the active material, wherein the first coating film comprises a first polymer comprising the one or more fluorinated polymers, wherein the combination of polymers in the first polymer have a fluorine content of about 60 atomic percent to about 90 atomic percent, based on a total content of the first polymer, and a second coating film 16, which is disposed on a top surface of the first coating film and includes a carbon nanostructure. A lithium battery comprising the composite cathode active material, on which the coating film having the double layered structure is disposed, may have improved rate characteristics and improved lifetime characteristics.

Although a thickness of the coating film is not particularly limited, the first and second coating films may each independently have a thickness of about 1 nanometer (nm) to about 200 nm, e.g., about 30 nm to about 200 nm, or about 40 nm to about 150 nm. When the coating film has the thickness in the foregoing range, a battery having improved charge/discharge rate characteristics and lifetime characteristics may be obtained.

Examples of the carbon nanostructure in the composite cathode active material may include one or more selected from a single-walled carbon nanotube, and a multi-walled carbon nanotube. For instance, the carbon nanotube (“CNT”) may have an average aspect ratio of about 300 or less, e.g., about 250 or less, and specifically about 50 to about 200, or about 75 to about 150.

“An average aspect ratio” is defined as a ratio of average length to average diameter, wherein “the average diameter” is defined as an average value of measured diameter values of the thickest portions of a plurality of carbon nanotubes after observing 10 or more carbon nanotubes in a Scanning Electron Microscope (“SEM”), and “the average length” is defined as an average value of measured length values of the carbon nanotubes after observing 10 or more carbon nanotubes using a Scanning Electron Microscope (“SEM”).

For instance, the carbon nanotubes may have an average diameter range of about 1 nm to about 50 nm or about 2 nm to about 50 nm. The carbon nanotubes having the foregoing average diameter may be evenly disposed on the core to improve electrical conductivities of the composite cathode active material so that charge/discharge characteristics of the battery is further improved.

The carbon nanotubes (“CNT”s) may be selectively subjected to an activation treatment, wherein the activation treatment, for instance, includes performing ultrasonic treatment of the treated carbon nanotubes (“CNT”s) after treating commercially available carbon nanotubes (“CNT”s) with one or more selected from an acid such as nitric acid and sulfuric acid, and an oxidizer such as potassium permanganate. When the carbon nanotubes (“CNT”s) are subjected to the activation treatment, a conductivity of the carbon nanotubes (“CNT”s) can be further improved.

FIG. 1A is a schematic diagram of an embodiment of a composite cathode active material 10.

Referring to FIG. 1A, a composite cathode active material includes a coating film 13 disposed on a core 10 comprising an active material that can intercalate and deintercalate lithium, the coating film including a carbon nanostructure 11 and a first polymer 12 comprising one or more fluorinated polymers, wherein the combination of polymers in the first polymer have a fluorine content of about 60 atomic percent to about 90 atomic percent, based on a total content of the first polymer. As shown in FIG. 1A, the coating film 13 may be in the form of a continuous film on the top of the core 10 comprising the active material. However, in another embodiment, the coating film may have a discontinuous film shape, e.g., an island shape.

The carbon nanotube (“CNT”) that is a carbon nanostructure in the coating film may have a shape in which the carbon nanotube (“CNT”) is embedded in, e.g., entirely embedded in, the coating film 13 or a shape in which the carbon nanotube (“CNT”) is partly exposed from the coating film 13 as shown in FIG. 1A.

The carbon nanostructure in the coating film may be partly molten and amorphized.

Such a composite cathode active material may effectively prevent a direct contact between an electrolyte and an active material of the core. Accordingly, dissolution of a cathode due to an oxidation reaction of the electrolyte can be inhibited or prevented, and charge/discharge rate characteristics and lifetime characteristics of the battery can be improved by reducing and increase in interfacial resistance values between the cathode and electrolyte from repeated charge/discharge cycles.

The coating film may have a thickness of about 1 nm to about 200 nm. For instance, the coating film may have a thickness of about 30 nm to about 200 nm, or about 50 nm to about 150 nm. A composite cathode active material including the coating film having the thickness in the foregoing range can minimize a resistance difference between the coating film interface and the composite oxide core interface that enables intercalation/deintercalation of lithium.

The active material as a compound for intercalation/deintercalation of lithium may have a layered structure or a spinel structure and can have a high operational voltage of 4.2 V or greater, e.g., a voltage of about 4.3 to about 5.5 V. For instance, the core active material may be one or more selected from an overlithiated layered oxide, a lithium manganese oxide, a lithium nickel manganese oxide, a lithium nickel manganese cobalt oxide, a lithium manganese oxide doped with a nonmetal elements, a lithium nickel manganese oxide doped with a nonmetal element, and a lithium nickel manganese cobalt oxide doped with a nonmetal element. The nonmetal may be one or more selected from C, P, S, F, Cl, Br, I B, N, and O.

For instance, the active material of the core may comprise a compound represented by Formula 1.

yLi[Li_{1/3}Me_{2/3}]O₂-(1-y)LiMe′O₂ Formula 1

In Formula 1, 0<y<1, Me is one or more selected from manganese (Mn), molybdenum (Mo), tungsten (W), vanadium (V), titanium (Ti), zirconium (Zr), ruthenium (Ru), rhodium (Rh), palladium (Pd), osmium (Os), iridium (Ir), and platinum (Pt), and Me′ is one or more selected from nickel (Ni), cobalt (Co), manganese (Mn), chromium (Cr), zirconium (Zr), niobium (Nb), copper (Cu), vanadium (V), titanium (Ti), zinc (Zn), aluminum (Al), gallium (Ga), magnesium (Mg), and boron (B), e.g., one or more selected from nickel (Ni), manganese (Mn), and cobalt (Co).

In the Formula 1, 0<y≦0.8.

In the Formula 1, Me may be represented by Formula 2.

M′ₐM_{b}Mn_{c} Formula 2

In Formula 2, M is one or more selected from molybdenum (Mo), tungsten (W), vanadium (V), titanium (Ti), zirconium (Zr), ruthenium (Ru), rhodium (Rh), palladium (Pd), osmium (Os), iridium (Ir), and platinum (Pt),

M′ is one or more selected from nickel (Ni), copper (Cu), zinc (Zn), cobalt (Co), chromium (Cr), iron (Fe), and magnesium (Mg), and

0≦a≦0.33, 0<b≦0.33, and a+b+c=1.

The active material may be one or more selected from compounds represented by Formulas 3 to 6.

LiₓCo_{1-y-z}Ni_{y}M_{z}O₂₋ₐXₐ Formula 3

In Formula 3, 0.9≦x≦1.6, 0≦y≦1, 0≦z≦1 and 0≦a≦1,

X is one or more selected from oxygen (O), fluorine (F), sulfur (S), and phosphorous (P), and

M is one or more selected from nickel (Ni), cobalt (Co), manganese (Mn), chromium (Cr), zirconium (Zr), niobium (Nb), copper (Cu), vanadium (V), titanium (Ti), zinc (Zn), aluminum (Al), gallium (Ga), magnesium (Mg), and boron (B).

LiₓMn_{2-y}M_{y}O₄₋ₐXₐ Formula 4

In Formula 4, 0.9≦x≦1.6, 0≦y≦1, 0≦z≦0.5 and 0≦a≦1,

X is one or more selected from oxygen (O), fluorine (F), sulfur (S), and phosphorous (P), and

M is one or more selected from nickel (Ni), cobalt (Co), manganese (Mn), chromium (Cr), zirconium (Zr), niobium (Nb), copper (Cu), vanadium (V), titanium (Ti), zinc (Zn), aluminum (Al), gallium (Ga), magnesium (Mg), and boron (B).

MFePO₄ Formula 5

In Formula 5, M is one or more selected from nickel (Ni), cobalt (Co), manganese (Mn), chromium (Cr), zirconium (Zr), niobium (Nb), copper (Cu), vanadium (V), titanium (Ti), zinc (Zn), aluminum (Al), gallium (Ga), magnesium (Mg), and boron (B).

LiₓM^{a}_{y}M^{b}_{z}PO_{4-d}X_{d} Formula 6

In Formula 6, 0.9≦x≦1.1, 0<y≦1, 0≦z≦1, 1.9≦x+y+z≦2.1 and 0≦d≦0.2;

M^{a} is one or more selected from the group consisting of iron (Fe), manganese (Mn), nickel (Ni), and cobalt (Co); and

M^{b} is one or more selected from the group consisting of magnesium (Mg), calcium (Ca), strontium (Sr), barium (Ba), titanium (Ti), zirconium (Zr), niobium (Nb), molybdenum (Mo), tungsten (W), zinc (Zn), aluminum (Al), silicon (Si), chromium (Cr), copper (Cu), vanadium (V), gallium (Ga), and boron (B); and

X is one or more selected from sulfur (S) and fluorine (F).

In the Formulas 3 and 4, x may be about 1.1 to about 1.6. The active material may comprise one or more selected from Li_{1.17}Ni_{0.17}Co_{0.1}Mn_{0.56}O₂, LiCoO₂, LiFePO₄, LiFe₁₋ₐMnₐPO₄ (0<a<1), LiNi_{0.5}Mn_{1.5}O₄, and LiMnPO₄, for example.

Since high voltage charge and discharge are desirable when a high capacity cathode active material including a large amount of lithium is used as the active material, it can be easy to decompose an electrolyte on the surface of a cathode. Accordingly, a transition metal such as Mn included in the lithium transition metal oxide may be dissolved by an electrolyte such that the transition metal can be easily eluted. Further, due to surface side reactions of the cathode, the battery may be easily subjected to self-discharge when the battery is stored, and a capacity of the battery may be reduced when performing charge/discharge cycles or during charging and discharging of the battery at high temperatures.

However, charge/discharge characteristics and lifetime characteristics of a lithium battery can be improved by using a composite cathode active material including a coating film according to an embodiment, thereby reducing or preventing dissolution between the active material of the core and the electrolyte, even under high voltages and/or high temperatures.

According to other aspect, provided is a method of preparing a composite cathode active material, the method including forming a coating film on a core comprising an active material, the coating film including a carbon nanostructure, and a first polymer comprising one or more fluorinated polymers, wherein the combination of polymers in the first polymer have a fluorine content of about 60 atomic percent to about 90 atomic percent, based on a total content of the first polymer.

The forming of the coating film may be performed according to a dry type process. Here, the dry type process includes any suitable processes of applying mechanical energy to the active material of the core, the first polymer, and the carbon nanostructure without using a solvent to form a coating film on the surface of the core.

For instance, the dry type process includes ball milling, a hybridization process, or a mechanofusion process, wherein examples of the ball milling process include a planetary ball mill process, a low speed ball milling process, and a high speed ball milling process.

The mechanofusion process may comprise injecting a mixture into a rotating container, fixing the mixture to an inner wall of the container by centrifugal force, and compressing the mixture through a gap between the inner wall of the container and an arm head that approaches to a slight distance from the inner wall of the container.

When the forming of the coating film is performed according to the dry type process, the forming of the coating film does not include performing heat treatment. If it is desired, the heat treatment may be performed within a range that the first polymer is not changed after forming the coating film. When the heat treatment is performed, a rigid coating film may be formed on the core by enhancing an adhesive strength of the coating film with respect to the core active material and removing impurities.

If desired, the coating film may be formed according to a wet type process.

Examples of the wet type process may include a spray process, a coprecipitation process, and a dipping process. For instance, the dipping process may be used as the wet type process.

For instance, the dipping process may include preparing a dispersion in which a carbon nanostructure and a core active material are dispersed in an organic solvent such as acetone, an alcohol such as methanol or ethanol, or N-methylpyrrolidone (“NMP”). The dipping process may additionally include dipping the core into the dispersion and heat-treating the core dipped into the dispersion.

A lithium battery according to other aspect may include: a cathode; an electrolyte; and an anode, wherein the cathode may include the composite cathode active material. For instance, the lithium battery may be manufactured as follows.

First, the cathode may be manufactured as follows by a cathode manufacturing method.

A composite cathode active material according to an embodiment, a conducting agent, a binder, and a solvent are mixed to prepare a cathode active material layer-forming composition.

The cathode active material layer-forming composition may be directly coated and dried on a current collector to manufacture a positive electrode plate on which a cathode active material layer is formed.

Alternatively, other cathode manufacturing methods may include casting the cathode active material layer-forming composition onto a separate support, delaminating the cast cathode active material layer-forming composition from the support to obtain a film, and laminating the film onto the current collector to manufacture a cathode on which the cathode active material layer is formed.

The cathode can be operated at about 4.2 V or greater, e.g., a high voltage of about 4.3 V to about 5.5 V.

Examples of the conducting agent for the cathode active material layer-forming composition may include one or more selected from carbon black, graphite particles, natural graphite, artificial graphite, acetylene black, Ketjen black, carbon fiber, carbon nanotubes, a metal powder, a metal fiber, or a metal tube of a metal such as copper, nickel, aluminum, or silver, and a conductive polymer such as a polyphenylene derivatives. However, the conducting agent is not limited to the foregoing examples, and it is possible that the conducting agent includes any suitable material that can be used as the conducting agent in the related art.

Examples of the binder may include one or more selected from a vinylidene fluoride/hexafluoropropylene copolymer, polyvinylidene fluoride, a polyimide, polyethylene, polyester, polyacrylonitrile, polymethylmethacrylate, polytetrafluoroethylene (“PTFE”), a carboxymethyl cellulose/styrene-butadiene rubber (“SMC/SBR”) copolymer, and a styrene butadiene rubber based polymer.

Examples of the solvent may include one or more selected from N-methylpyrrolidone, acetone, and water. However, the solvent is not limited to the examples, and any suitable solvent can be used.

Amounts of the composite cathode active material, the conducting agent, the binder and the solvent may be determined by one of skill in the art without undue experimentation.

When manufacturing a cathode, the cathode may additionally include a first cathode active material such as that which is used in lithium batteries in addition to the above-described composite cathode active material. For instance, the first cathode active material may be contained in an amount of about 0.1 part by weight to about 30 parts by weight with respect to 100 parts by weight of the composite cathode active material.

Examples of the first cathode active material may include one or more selected from lithium cobalt oxide, lithium nickel manganese cobalt oxide, lithium nickel cobalt aluminum oxide, lithium iron phosphorous oxide, and lithium manganese oxide. However, the first cathode active material is not limited to the examples, and any suitable cathode active material may be used as the first cathode active material.

Examples of the first cathode active material may include compounds represented by any one of Formulas of: LiₐA_{1-b}R_{b}R′₂, where 0.90≦a≦1.8, and 0≦b≦0.5; LiₐE_{1-b}R_{b}O_{2-b}R′_{c}, where 0.90≦a≦1.8, 0≦b≦0.5, 0≦c≦0.05; LiE_{2-b}R_{b}O_{4-c}D_{c}, where 0≦b≦0.5, 0≦c≦0.05; LiₐNi_{1-b-c}Co_{b}R_{c}Dₐ, where 0.90≦a≦1.8, 0≦c≦0.05, 0<a≦2; LiₐNi_{1-b-c}Co_{b}R_{c}O₂₋ₐFₐ, where 0.90≦a≦1.8, 0≦b≦0.5, 0≦c≦0.05, 0<a<2; LiₐNi_{1-b-c}Co_{b}R_{c}O₂₋ₐR′″₂, where 0.90≦a≦1.8, 0≦b≦0.5, 0≦c≦0.05, 0<a≦2; LiₐNi_{1-b-c}Mn_{b}R_{c}Dₐ, where 0.90≦a≦1.8, 0≦b≦0.5, 0≦c≦0.05, 0<a<2; LiₐNi_{1-b-c}Mn_{b}R_{c}O₂₋ₐR′″ₐ, where 0.90≦a≦1.8, 0≦b≦0.5, 0≦c≦0.05, 0<a<2; LiₐNi_{1-b-c}Mn_{b}R_{c}O₂₋ₐR′″₂, where 0.90≦a≦1.8, 0≦b≦0.5, 0≦c≦0.05, 0<a<2; LiₐNi_{b}E_{c}G_{d}O₂, where 0.90≦a≦1.8, 0≦b≦0.8, 0≦c≦0.5, 0≦d≦0.1; LiₐNi_{b}Co_{c}Mn_{d}GₑO₂, where 0.90≦a≦1.8, 0≦b≦0.9, 0≦c≦0.5, 0≦d≦0.5, 0.001<e<0.1; LiₐNiG_{b}O₂, where 0.90≦a≦1.8, 0.001≦b≦0.1; LiₐCoG_{b}O₂, where 0.90≦a≦1.8, 0.001≦b≦0.1; LiₐMnG_{b}O₂, where 0.90≦a≦1.8, 0.001≦b≦0.1; LiₐMn₂G_{b}O₄, where 0.90≦a≦1.8, 0.001≦b≦0.1; QO₂; QS₂; LiQS₂; V₂O₅; LiVO₅; LiQ′O₂; LiNiVO₄; Li_{(3-f)}J₂(PO₄)₃, where 0≦f≦2; Li_{(3-f)} Fe₂(PO₄)₃, where 0≦f≦2; and LiFePO₄.

In the above-described Formulas, A is one or more selected from nickel (Ni), cobalt (Co), and manganese (Mn); R is one or more selected from aluminum (Al), nickel (Ni), cobalt (Co), manganese (Mn), chromium (Cr), iron (Fe), magnesium (Mg), strontium (Sr), vanadium (V), and a rare-earth element; R′ is one or more selected from oxygen (O), fluorine (F), S (sulfur), and phosphorous (P); E is one or more selected from cobalt (Co), and manganese (Mn); R′″ is one or more selected from fluorine (F), sulfur (S), phosphorous (P), or combinations thereof; G is aluminum (Al), chromium (Cr), manganese (Mn), iron (Fe), magnesium (Mg), lanthanum (La), cerium (Ce), strontium (Sr), and vanadium (V); Q is one or more selected from titanium (Ti), molybdenum (Mo), and manganese (Mn); Q′ is one or more selected from chromium (Cr), vanadium (V), iron (Fe), scandium (Sc), and yttrium (Y); and J is one or more selected from vanadium (V), chromium (Cr), manganese (Mn), cobalt (Co), nickel (Ni), and copper (Cu).

The amount of the composite cathode active material, the conducting agent, the binder and the solvent may be determined by one of skill in the art without undue experimentation. If desired, one or more of the conducting agent, the binder and the solvent may be omitted.

An anode may be obtained by performing manufacturing of the anode according to an anode manufacturing process that may be similar to the cathode manufacturing process except that an anode active material instead of the cathode active material is used in the cathode manufacturing process.

Examples of the anode active material include one or more selected from a carbon-based material, silicon, a silicon oxide, a silicon-based alloy, they silicon-carbon based material complex, tin, they tin-based alloy, a tin-carbon complex, and they metal oxide.

The carbon-based material may be one or more selected from a crystalline carbon, and an amorphous carbon. Examples of the crystalline carbon may include a graphite such as an amorphous, plate-shaped, flake-shaped, spherical shaped or fiber-type natural graphite or an artificial graphite, and examples of the amorphous carbon may include a soft carbon or a low temperature baked carbon, a hard carbon, a mesophase pitch carbide, a baked coke, graphene, a carbon black, fullerene soot, a carbon nanotube, and carbon fiber. However, the crystalline carbon and the amorphous carbon are not limited to the foregoing examples, and any suitable crystalline carbon or the amorphous carbon can be used as the crystalline carbon and the amorphous carbon.

The anode active material may be selected from one or more selected from silicon (Si), SiOₓ (0<x<2, e.g., 0.5 to 1.5), Sn, SnO₂, and a silicon-containing metal alloy. The silicon-containing metal alloy may include one or more metals selected from aluminum (Al), tin (Sn), silver (Ag), iron (Fe), bismuth (Bi), magnesium (Mg), zinc (Zn), indium (In), germanium (Ge), lead (Pb), and titanium (Ti).

Examples of the anode active material may include a metals and/or metalloid that is alloyable with lithium, and an alloy or oxide thereof. For instance, the metals and/or metalloids that is alloyable with lithium may include silicon (Si), tin (Sn), aluminum (Al), germanium (Ge), lead (Pb), bismuth (Bi), a SbSi-L alloy (wherein L is not Si, and may be one or more selected from an alkali metal, an alkali earth metal, an element of Group 13, an element of Group 14, a transition metal, and a rare-earth element), a Sn-L′ alloy (wherein L′ is not Sn, and is one or more selected from an alkali metal, and alkali earth metal, and element of Group 13, an element of Group 14, a transition metal, and a rare-earth element), and MnOx (0<x≦2). Examples of the element L′ may include one or more selected from magnesium (Mg), calcium (Ca), strontium (Sr), barium (Ba), radium (Ra), scandium (Sc), Y (yttrium), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorous (P), arsenic (As), antimony (Sb), bismuth (Bi), sulfur (S), selenium (Se), tellurium (Te), and polonium (Po). For instance, oxides of the metal and/or metalloid that are alloyable with lithium may include one or more selected from a lithium titanium oxide, a vanadium oxide, a lithium vanadium oxide, SnO₂, and SiOₓ (0<x<2).

Examples of the anode active material may include one or more elements selected from elements of Groups 13, 14, and 15 of Periodic Table of the Elements.

Examples of the anode active material may include one or more elements selected from silicon (Si), germanium (Ge), and tin (Sn).

The amounts of the anode active material, the conducting agent, the binder, and the solvent may be determined by one of skill in the art without undue experimentation.

A separator may be interposed between the cathode and the anode, and an insulating thin film having a high ion permeability and a high mechanical strength may be used the separator.

The separator may have a pore diameter of about 0.01 micrometers (μm) to about 10 μm, and may have a thickness of about 5 μm to 20 μm. Examples of the separator may include non-woven fabrics or sheets made from glass fiber, polyethylene, or an olefin based polymer such as polypropylene. When a solid polymer electrolyte is used as the electrolyte, the solid polymer electrolyte may also be used as the separator.

Examples of the separator made from the olefin based polymer may include a multilayered films having one layer or more of polyethyelene, polypropylene, and polyvinylidene fluoride, and a mixed multilayered film such as a polyethylene/polypropylene two-layered separator, a polyethylene/polypropylene/polyethylene three-layered separator, and a polypropylene/polyethylene/polypropylene three-layered separator may be used.

The lithium salt-containing non-aqueous electrolyte may comprise a non-aqueous electrolyte and a lithium salt.

The non-aqueous electrolyte may comprise one or more selected from a non-aqueous electrolytic solution, an organic solid electrolyte, and an inorganic solid electrolyte.

The non-aqueous electrolytic solution includes an organic solvent. The organic solvents may include any suitable materials that can be used as the organic solvents in the related art. Examples of the organic solvents may include one or more selected from propylene carbonate, ethylene carbonate, fluoroethylene carbonate, butylenes carbonate, dimethyl carbonate, diethyl carbonate, methylethyl carbonate, methylpropyl carbonate, ethylpropyl carbonate, methylisopropyl carbonate, dipropyl carbonate, dibutyl carbonate, fluoroethylene carbonate, benzonitrile, acetonitrile, tetrahydrofuran, 2-methyltetrahydrofuran, γ-butyrolactone, dioxolane, 4-methyldioxolane, N,N-dimethylformamide, N,N-dimethylacetamide, N,N-dimethylsulfoxide, dioxane, 1,2-dimethoxyethane, sulforane, dichloroethane, chlorobenzene, nitrobenzene, diethyleneglycol, and dimethylether.

Examples of the organic solid electrolyte may include one or more selected from a polyethylene derivative, a polyethylene oxide derivative, a polypropylene oxide derivative, a phosphate ester polymer, polyagitation lysine, a polyester sulfide, a polyvinyl alcohol, polyvinylidene fluoride, and an ionic dissociable group-including polymer.

Examples of the inorganic solid electrolyte may include one or more selected from a Li nitride, a Li halide, and a Li sulfate such as Li₃N, LiI, Li₅NI₂, Li₃N—LiI—LiOH, Li₂SiS₃, Li₄SiO4, Li4SiO₄—LiI—LiOH and Li₃PO₄—Li₂S—SiS₂.

Examples of the lithium salt as a materials that can be dissolved into the non-aqueous electrolyte may include one or more selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are natural numbers), LiCl, and LiI. For the purpose of improving charge/discharge characteristics and flame retardancy of the non-aqueous electrolyte, the non-aqueous electrolyte may include one or more selected from pyridine, triethyl phosphate, triethanol amine, a ring-shaped ether, ethylene diamine, n-glyme, hexamethyl phosphoramide, nitrobenzene derivatives, sulfur, quinone imine dyes, N-substituted oxazolidinones, N, N-substituted amidazolidine, ethylene glycol dialkyl ether, ammonium salts, pyrrole, 2-methoxy ethanol, and aluminum trichloride. If desired, the non-aqueous electrolyte may additionally include a halogen-containing solvent such as carbon tetrachloride and ethylene trifluoride to enhance the incombustibility of the non-aqueous electrolyte.

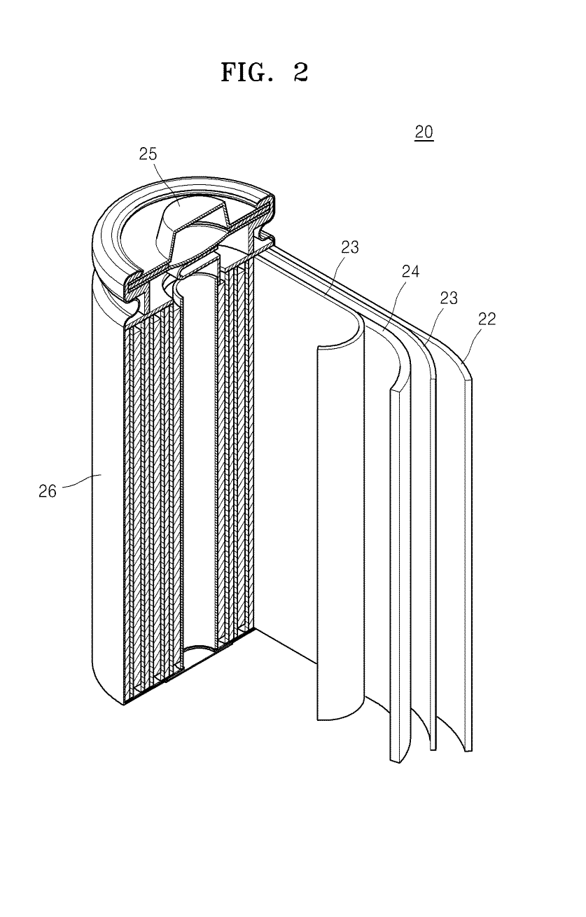

As shown in FIG. 2, the lithium battery 20 includes a cathode 23, an anode 22 and a separator 24. The above-described cathode 23, anode 22 and separator 24 maybe wound or folded such that the wound or folded cathode 23, anode 22 and separator 24 are housed in a battery case 26. Subsequently, an organic electrolytic solution is injected into the battery case 26, the battery case 26 containing the organic electrolytic solution is sealed by a cap assembly 25 such that a lithium battery 21 is completed. The battery case may be formed in a cylindrical shape, a rectangular shape, or a thin film shape, for example. For instance, the lithium battery may be a thin film shaped battery. The lithium battery may be a lithium ion battery.

The separator may be disposed between the cathode and the anode such that a battery structure can be formed. After the battery structure is laminated in a bi-cell structure, the battery structure is impregnated with an organic electrolytic solution to obtain a resulting material, the resulting material is housed in a pouch, and the resulting material housed in the pouch is sealed such that a lithium ion polymer battery is completed.

Further, a plurality the batteries may be laminated to form a battery pack, and the battery pack can be used in any suitable device in which high capacity and high output power are desirable. For instance, the battery pack can be used in a notebook, a smart phone, or an electric vehicle, for example

The lithium battery may provide improved charge/discharge efficiency and capacity. While not wanting to be bound by theory, it is understood that the properties are provided by the improved electrical conductivity of the battery. Further, the lithium battery as reduced resistance according to charge/discharge rate to provide high charge/discharge rate, and the lithium battery inhibits a side reaction on the surface of an electrode and effectively prevents dissolution of an electrolyte on the surface of the cathode to lengthen the lifetime of the battery. As is further described above, the lithium battery provides improved high-rate characteristics and improved lifetime characteristics such that the lithium battery is suitable for electric vehicles (“EV”s). For instance, the lithium battery is suitable for hybrid vehicles such as plug-in hybrid electric vehicles (“PHEV”s).

Hereinafter, although the present disclosure is described more in detail by the Examples, the present disclosure is not limited thereto.

### Examples

### Preparation Example 1

### Preparation of Composite Cathode Active Material

100 parts by weight of Li_{1.17}Ni_{0.17}Co_{0.1}Mn_{0.56}O₂ as an active material, 1 part by weight of a single-walled carbon nanotube (a product of Nanotec Corporation, purity: 90% or higher, average diameter: 2 mm, average length: 30 μm), and 0.5 weight part of polytetrafluoroethylene were mixed and milled at about 3,000 rpm for about 30 minutes using a Nobilta (NOB-MINI, Hosokawa Micron Corporation) mixer to prepare a composite cathode active material including a coating film of the single-walled carbon nanotube and polytetrafluoroethylene formed on a core of the active material.

The composite cathode active material obtained according to the above-described process included 1 part by weight of the carbon nanotube (“CNT”), 0.5 part by weight of polytetrafluoroethylene, and 98.5 parts by weight of the core.

### Preparation Examples 2 to 4

### Preparation of Composite Cathode Active Materials

Composite cathode active materials were prepared by performing preparation processes in the same method as Preparation Example 1 except that the content of polytetrafluoroethylene changed from 0.5 part by weight to 0.2 part by weight, 1 part by weight and 5 parts by weight respectively.

### Comparative Preparation Example 1

### Cathode Active Material

Li_{1.17}Ni_{0.17}Co_{0.1}Mn_{0.56}O₂ as a cathode active material was used.

### Comparative Preparation Example 2

### Preparation of Cathode Active Material

A cathode active material was prepared by performing a preparation process in the same method as Preparation Example 1 except that the single-walled carbon nanotube was not used.

### Comparative Preparation Example 3

### Preparation of Cathode Active Material

A cathode active material was prepared by performing a preparation process in the same method as Preparation Example 1 except that the single-walled carbon nanotube was not used, and the content of polytetrafluoroethylene changed from 0.5 parts by weight to 1 part by weight.

### Comparative Preparation Example 4

### Preparation of Cathode Active Material

A cathode active material was prepared by performing a preparation process in the same method as Preparation Example 1 except that polytetrafluoroethylene was not used, and 1 part by weight of the single-walled carbon nanotube was used.

### Example 1

### Manufacturing of Cathode and Coin Cell

A mixture obtained by mixing the composite cathode active material prepared in Example 1, a carbon conducting agent (Denka Black), and polyvinylidenefluoride (“PVdF”) at a weight ratio of 92:4:4 was mixed with N-methylpyrrolidone (“NMP”) in an agate mortar to prepare a slurry. The slurry was bar-coated on an aluminum current collector with a thickness of about 15 μm and dried at room temperature, and then the dried slurry was dried again at vacuum conditions and at about 120° C. and rolled and punched to manufacture a cathode with a thickness of about 55 μm.

The cathode, lithium metal as a counter electrode, polytetrafluoroethylene (“PTFE”) as a separator, and a solution as an electrolyte obtained by dissolving 1.3 molar (M) LiPF₆ into a mixture of ethylene carbonate (“EC”), diethyl carbonate (“DEC”) and ethylmethyl carbonate (“EMC”) having a volume ratio of 3:5:2 were used to manufacture a coin cell.

### Examples 2 to 4

### Manufacturing of Cathodes and Coin Cells

Cathodes and coin cells were manufactured by performing preparation processes in the same method as Example 1 except that the composite cathode active materials prepared according to Examples 2 to 4 were used instead of the composite cathode active material prepared in Example 1.

### Comparative Examples 1 to 4

### Manufacturing of Cathodes and Coin Cells

Cathodes and coin cells were manufactured by performing preparation processes in the same method as Example 1 except that the composite cathode active materials prepared according to Comparative Examples 1 to 4 were used instead of the composite cathode active material prepared in Example 1.

### Comparative Example 5

### Manufacturing of Cathode and Coin Cell

A mixture obtained by mixing Li_{1.17}Ni_{0.17}CO_{0.1}Mn_{0.56}O₂ as a cathode active material, a single-walled carbon nanotube (a product of Nanotec Corporation, purity: 90% or higher, average diameter: 2 mm, average length: 30 μm), and polytetrafluoroethylene at a weight ratio of 92:4:4 was mixed with N-methylpyrrolidone (“NMP”) in an agate mortar to prepare a slurry. The slurry was bar-coated on an aluminum current collector with a thickness of about 15 μm and dried at room temperature, and then the dried slurry was dried again at conditions of vacuum and about 120° C. and rolled and punched to manufacture a cathode with a thickness of about 55 μm.

The cathode, lithium metal as a counter electrode, polytetrafluoroethylene (“PTFE”) as a separator, and a solution as an electrolyte obtained by dissolving 1.3M LiPF₆ into a mixture of ethylene carbonate (“EC”), diethyl carbonate (“DEC”) and ethylmethyl carbonate (“EMC”) having a volume ratio of 3:5:2 were used to manufacture a coin cell.

### Evaluation Example 1

### Scanning Electron Microscopy (“SEM”) Analysis

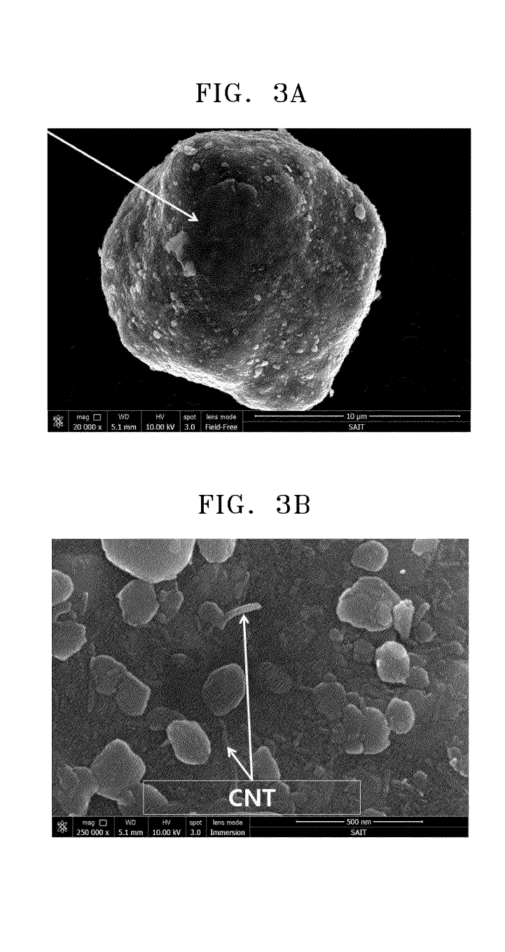

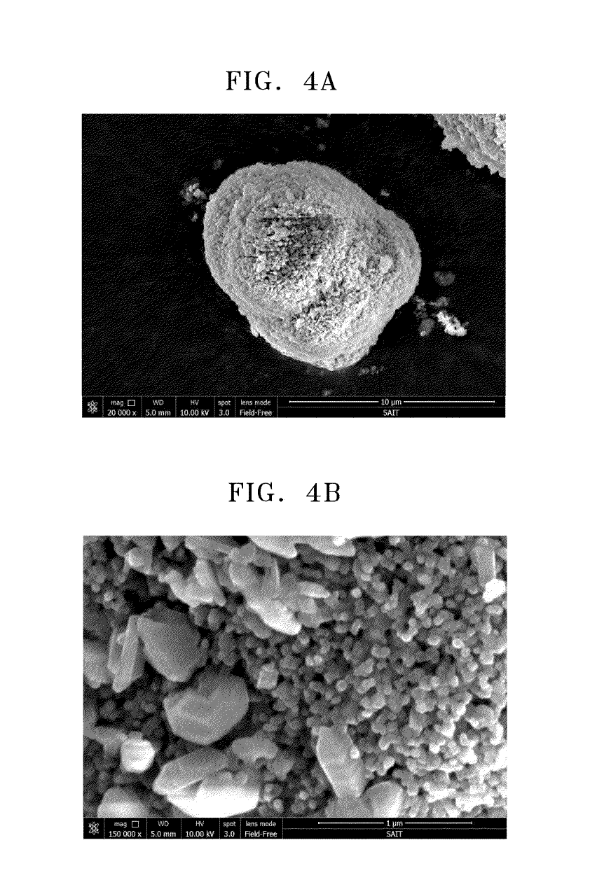

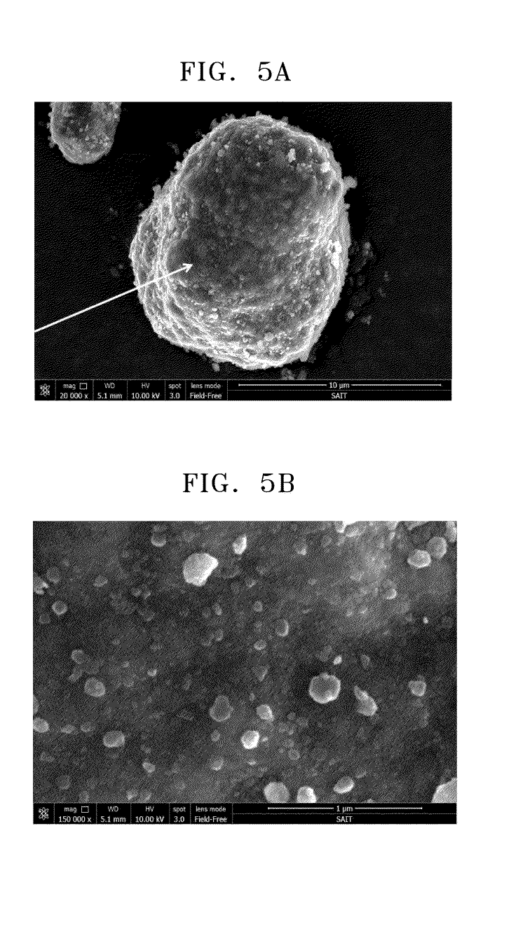

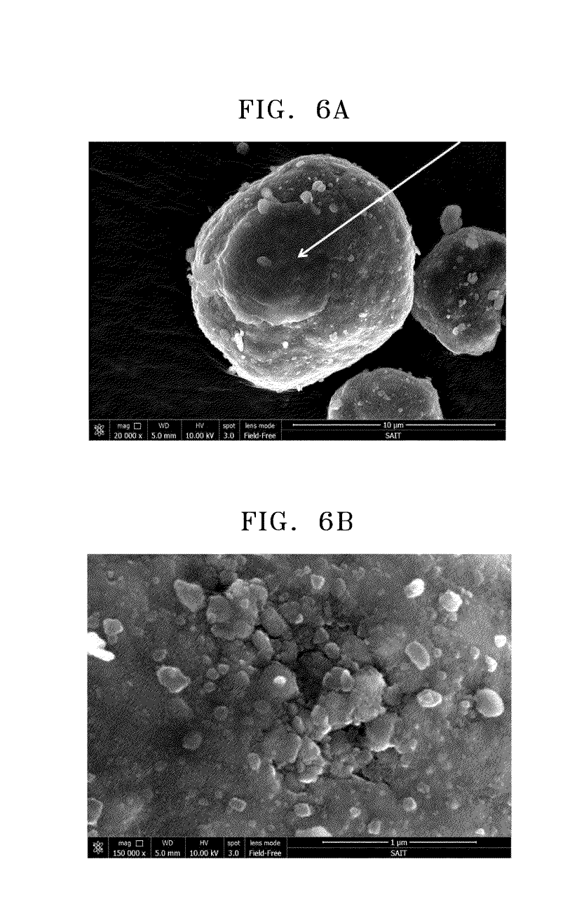

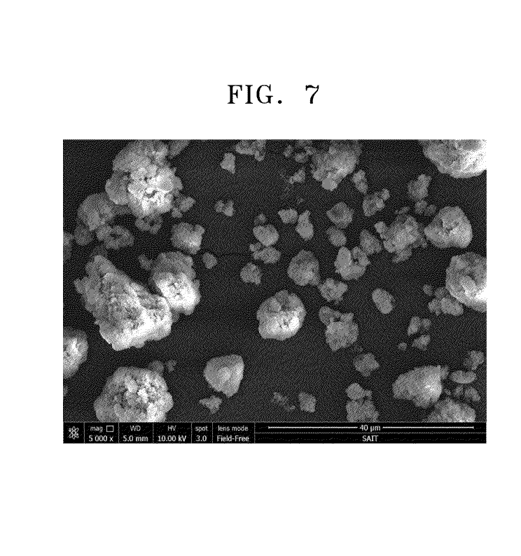

A Scanning Electron Microscopy (“SEM”) analysis process was performed on the cathode active material of Comparative Preparation Example 1, the cathode active materials of Comparative Preparation Examples 2 and 3, and the cathode active material obtained according to Preparation Example 1. The Scanning Electron Microscopy (“SEM”) analysis process included observing the cathode active material of Comparative Preparation Example 1, the cathode active materials of Comparative Preparation Examples 2 and 3, and the cathode active material obtained according to Preparation Example 1 using a Scanning Electron Microscope (“SEM”, a product manufactured by Hitachi Corporation, Model name: S-5500) as respectively shown in FIGS. 3A to 6A. FIGS. 3B to 6B show SEM pictures obtained by expanding the pictures of FIGS. 3A to 6A respectively. A SEM picture of polytetrafluoroethylene (“PTFE”) was illustrated in FIG. 7 for the purpose of comparison with the cathode active material obtained according to Preparation Example 1.

Referring to FIG. 7, it could be seen that the surface of cathode active material is coated with polytetrafluoroethylene (“PTFE”) and carbon nanotube (“CNT”).

### Evaluation Example 2

### Scanning Electron Microscope-Energy Dispersive Spectroscopy (“SEM-EDS”)

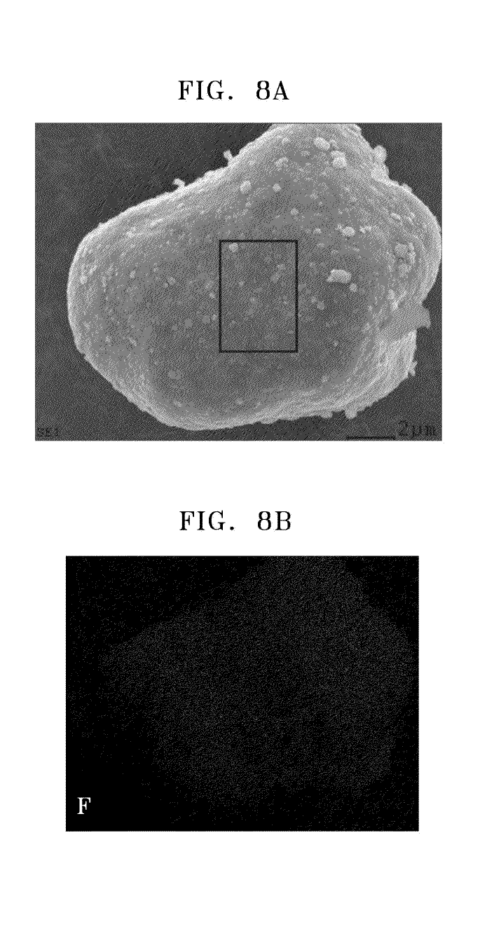

The composite cathode active material obtained according to Preparation Example 1 was analyzed using a Scanning Electron Microscope (“SEM”). An analysis result is illustrated in FIG. 8A, and a SEM-EDS result for fluorine in a square-marked area of FIG. 8A is illustrated in FIG. 8B.

Referring to FIG. 8B, it could be seen that the surface of the core active material is evenly coated with polytetrafluoroethylene (“PTFE”).

### Evaluation Example 3

### Scanning Electron Microscope-Focusing Ion Beam (“SEM-FIB”) Analysis

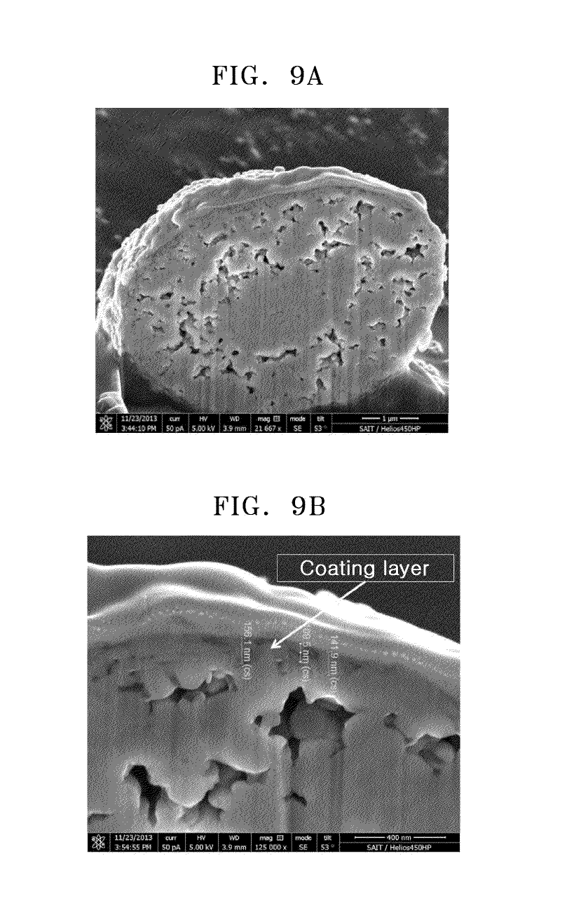

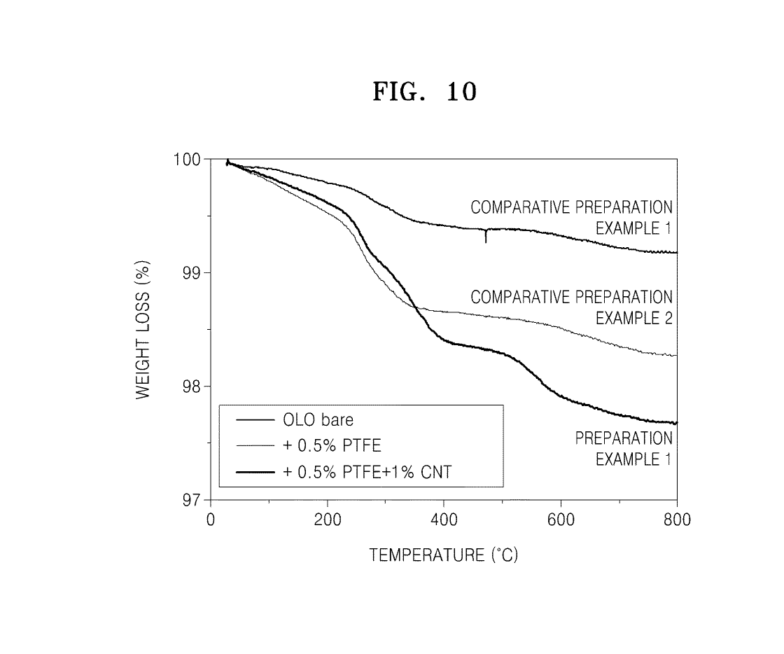

A SEM-FIB analysis was performed on cross-section and surface of the composite cathode active material obtained according to Preparation Example 1. The analysis results on the cross-section and the surface of the composite cathode active material were respectively illustrated in FIG. 9A and FIG. 9B.

Referring to FIGS. 9A and 9B, it could be confirmed that a coating film was formed on the surface of the core active material.

### Evaluation Example 4

### Thermogravimetric Analysis (“TGA”)

Thermogravimetric Analysis was performed on the cathode active materials of Comparative Preparation Examples 1 to 2 and the composite cathode active material of Preparation Example 1 using a TA Instrument SDF-2960.

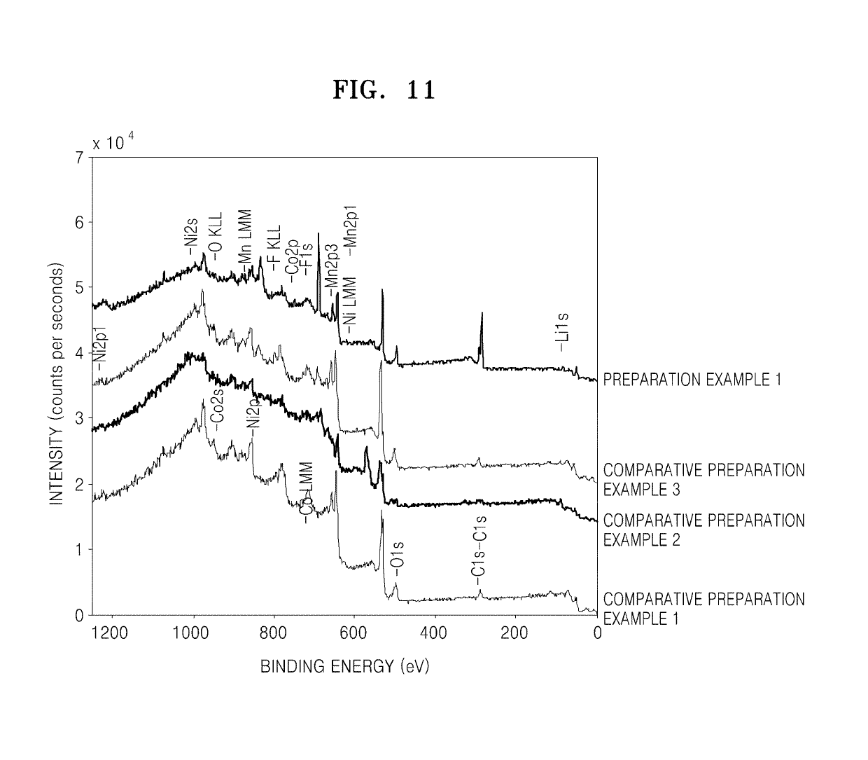

The analysis results are illustrated in FIG. 10.

Referring to FIG. 10, it was possible to confirm content ranges of polytetrafluoroethylene (“PTFE”) and carbon nanotube (“CNT”) presenting in the composite active material of Preparation Example 1.

### Evaluation Example 5

### X-Ray Photoelectron Spectroscopy (“XPS”) Analysis

X-ray photoelectron spectroscopy (“XPS”) analysis was performed on the composite cathode active material of Preparation Example 1 and the cathode active materials of Comparative Preparation Examples 1 to 3 according to the following conditions.

After samples were dried at about 100° C. under vacuum for about 4 hours, the XPS analysis was performed using a Physical Electronics Quantum 2000 Scanning ESCA Microbe manufactured by Physical Electronics Corporation as an XPS analyzer and using a monochromatic Al-Kα X-ray source (1486.6 eV) operated at 27.7 W.

The analysis results are represented in Table 1 and FIG. 11.

TABLE 1

| | Content (atomic %) | | | | | | |
|---|---|---|---|---|---|---|---|
| Classification | C1s | O1s | F1s | Na1s | Mn2p | Co2p | Ni2p |
| Preparation | 49.31 | 23.13 | 16.07 | 2.16 | 5.8 | 0.67 | 2.87 |
| Example 1 | | | | | | | |
| Comparative | 10.74 | 53.77 | 0 | 6.18 | 16.81 | 2.99 | 9.51 |
| Preparation | | | | | | | |
| Example 1 | | | | | | | |
| Comparative | 15.2 | 52.99 | 4.72 | 3.63 | 16.44 | 2.28 | 4.76 |
| Preparation | | | | | | | |
| Example 2 | | | | | | | |
| Comparative | 15.63 | 52.95 | 6.44 | 4.04 | 14.66 | 1.6 | 4.69 |
| Preparation | | | | | | | |
| Example 3 | | | | | | | |

Referring to the Table 1, changes were observed in the fluorine bond state when comparing a case in which a coating film containing CNT and PTFE was formed according to Preparation Example 1 with the case of Comparative Preparation Example 2. A carbon content corresponding to C1 s and a fluorine content corresponding to F1s were high when comparing the case of Preparation Example 1 with that of Comparative Preparation Example 1. Therefore, it could be seen that a coating film containing PTFE and CNT was formed on the surface of the core active material.

### Evaluation Example 6

### Evaluation of Lifetime Characteristics

### 1) Example 1 and Comparative Examples 1 to 4

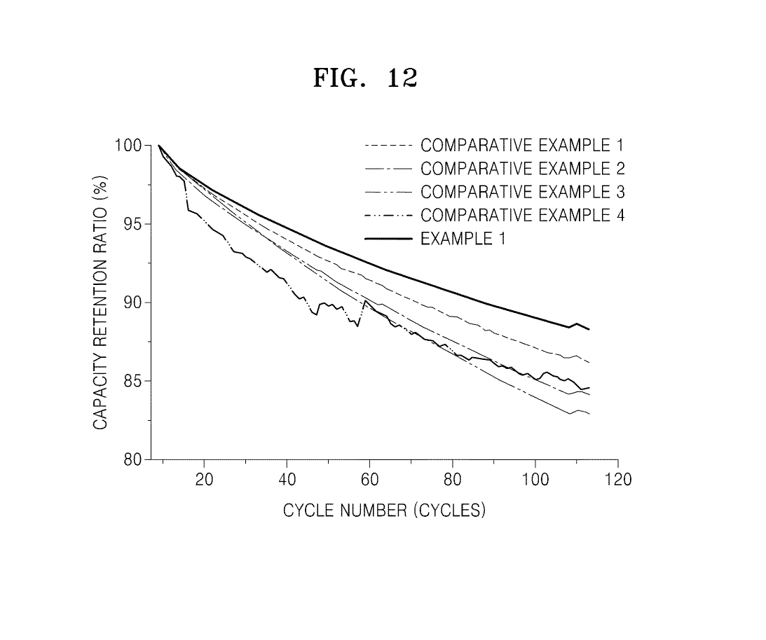

The coin cells manufactured according to Example 1 and Comparative Examples 1 to 4 were charged and discharged 120 times to a constant current of 1 C rate in a voltage range of about 2.5 V to about 4.6 V compared to lithium metal at a high temperature of about 45° C. A capacity retention ratio at the 120^{th} cycle is represented by Mathematical Expression 1. A part of the capacity retention ratio at the 120^{th} cycle was illustrated in FIG. 12.

Capacity retention ratio [%] at the 120^{th} cycle=[discharge capacity at the 120^{th} cycle/discharge capacity at the first cycle]×100% Mathematical Expression 1

As shown in FIG. 12, the coin cell of Example 1 shown improved lifetime characteristics compared to those of the coin cells of Comparative Examples 1 to 4.

### Example 1 and Comparative Example 5

Lifetime characteristics of the coin cells of Example 1 and Comparative Example 5 were evaluated in the same lifetime characteristic evaluating method as those of Example 1 and Comparative Examples 1 to 4.

As results of the analysis, it could be seen that the coin cell of Example 1 had improved lifetime characteristics compared to that of Comparative Example 5.

### Evaluation Example 8

### Rate Capability

### 1) Example 1 and Comparative Examples 1 to 4

After the coin cells manufactured according to Example 1 and Comparative Examples 1 to 4 were charged at room temperature (25° C.) under conditions of a constant current (0.5 C) and a constant voltage (4.5V, 0.05 C cut-off), the charged coin cells were rested for about 10 minutes. Subsequently, the coin cells were discharged until a voltage becomes 2.5V under conditions of a constant current (0.2 C or 2 C). Namely, as discharge rates of the coin cells were changed to 0.2 C and 2 C respectively, rate capabilities of the coin cells were evaluated. The evaluation results were represented in Table 2. C-rates were determined by dividing a total capacity of each cell by its total discharge time to provide a mean discharge rate for each cell. Rate capabilities in Table 3 are obtained by Mathematical Expression 2, and voltage reductions are obtained by Mathematical Expression 3.

Rate capability (%)=[(discharge capacity at 2 C)/(discharge capacity at 0.2 C)]×100% Mathematical Expression 2

Voltage decay=(discharge voltage at the 100^{th} cycle−discharge voltage at the second cycle) Mathematical Expression 3

TABLE 2

| Classification | Rate capability (%) | Voltage decay (ΔV) |
|---|---|---|
| Example 1 | 79.6 | 0.142 |
| Comparative Example 1 | 72.8 | 0.16 |
| Comparative Example 2 | 69.4 | 0.145 |
| Comparative Example 3 | 67.5 | 0.142 |
| Comparative Example 4 | 81.3 | 0.17 |

Referring to Table 3, although rate capability of the coin cell manufactured according to Comparative Example 4 was improved, a large voltage reduction width of the coin cell was exhibited by using a cathode active material on which a CNT-containing coating film was formed.

On the other hand, it could be seen that rate capability of the coin cell manufactured according to Example 1 was also improved by CNT of the coating film while delay effect of the voltage decay was further improved in the coin cell manufactured according to Example 1 compared to coin cells of Comparative Examples 1 to 4 by employing an electrode using a composite cathode active material on which a coating film containing PTFE and CNT was formed.

### 2) Examples 1 to 4 and Comparative Example 1

After the coin cells manufactured according to Examples 1 to 4 and Comparative Example 1 were charged at room temperature (25° C.) under conditions of a constant current (0.5 C) and a constant voltage (4.5V, 0.05 C cut-off), the charged coin cells were rested for about 10 minutes. Subsequently, the coin cells were discharged until a voltage becomes 2.5V under conditions of a constant current (0.2 C or 2 C). Namely, as discharge rates of the coin cells were changed to 0.2 C and 2 C respectively, rate capabilities of the coin cells were evaluated. The evaluation results were represented in Table 3. A “C-rate,” e.g., discharge rate, of each cell was determined by dividing the total capacity of the cell by the total discharge time. Rate capabilities in Table 3 are obtained by Mathematical Expression 4.

Rate capability (%)=[(discharge capacity at 2 C)/(discharge capacity at 0.2 C)]×100% Mathematical Expression 4

TABLE 3

| Classification | Rate capability (%) |
|---|---|
| Example 1 | 81.2 |
| Example 2 | 79.6 |
| Example 3 | 79.3 |
| Example 4 | 76.6 |
| Comparative Example 1 | 76.1 |

Referring to Table 3, it could be seen that rate capabilities were improved in the coin cells of Examples 1 to 4 compared to rate capability in the coin cell of Comparative Example 1.

### 3) Example 1 and Comparative Example 6

Rate capabilities of the coin cells of Example 1 and Comparative Example 6 were evaluated in the same method as rate capability performance evaluating methods of the above-described Example 1 and Comparative Examples 1 to 4.

As an evaluation result, it could be seen that rate capability of the coin cell of Example 1 was improved compared to rate capability of the coin cell of Comparative Example 6.

### Evaluation Example 9

### Specific Capacity

### 1) Example 1 and Comparative Examples 1 to 4

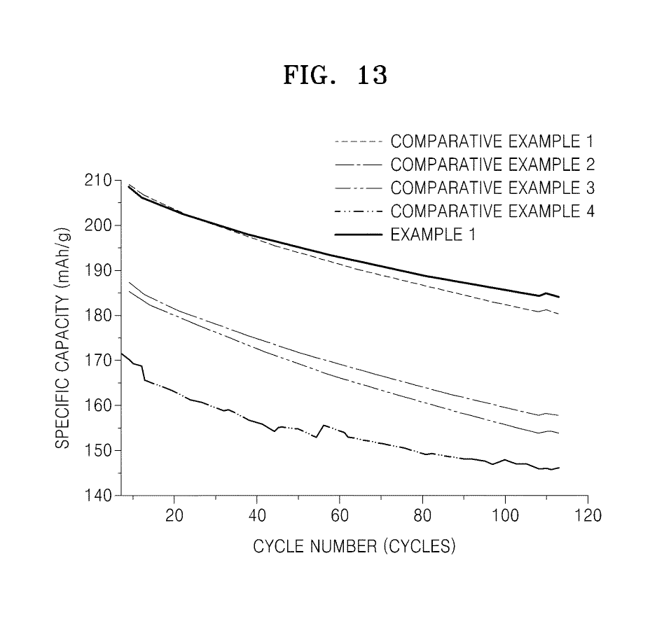

A charge/discharge process having 120 charge/discharge cycles was performed on the coin cells manufactured according to Example 1 and Comparative Examples 1 to 4 to a constant current of 1 C rate in a voltage range of about 2.5V to about 4.6V compared to lithium metal at a high temperature of about 45° C. The charge/discharge process having 120 charge/discharge cycles was repeatedly performed, and specific capacities according to number of the respective cycles were measured to illustrate the measured specific capacities in FIG. 13.

As shown in FIG. 13, the lithium battery of Example 1 shown improved specific capacity characteristics compared to those of the coin cells of Comparative Examples 1 to 4.

### 2) Examples 1 to 2 and Comparative Example 1

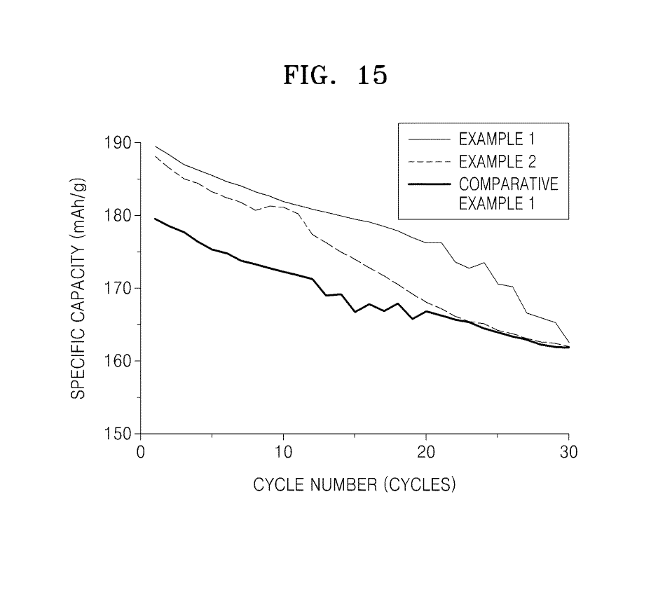

A charge/discharge process having 120 charge/discharge cycles was performed on the coin cells manufactured according to Examples 1 to 2 and Comparative Example 1 to a constant current of 1 C rate in a voltage range of about 2.5V to about 4.6V compared to lithium metal at a high temperature of about 45° C. The charge/discharge process having 120 charge/discharge cycles was repeatedly performed, and specific capacities according to number of the respective cycles were measured to illustrate the measured specific capacities in FIG. 15.

As shown in FIG. 15, it could be seen that specific capacity characteristics of the coin cells of Examples 1 to 2 were more improved than those of the coin cell of Comparative Example 1, and specific capacity characteristics of the coin cell were more excellent than those of the coin cell of Example 2.

### Evaluation Example 10

### Adhesive Strength Test

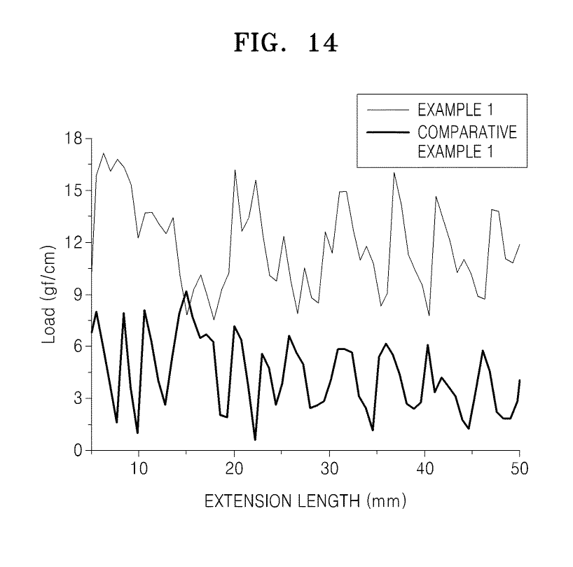

T-peel tests (ASTM D1876) were performed on the cathodes obtained according to Example 1 and Comparative Example 1, and the test results were shown in FIG. 14.

Referring to FIG. 14, peel strength of the cathode of Example 1 was increased compared to that of the cathode of Comparative Example 1. It could be seen from this that electrode binding strength was improved in the cathode of Example 1 than that of Comparative Example 1, and lifetime characteristics of the coin cell of Example 1 employing the cathode were improved compared to those of the coin cell of Comparative Example 1 according as the electrode binding strength was improved.

As described above, according to the one or more of the above embodiments, the composite cathode active material includes a coating film, and the coating film includes a core comprising an active material, a fully fluorinated polymer formed on at least a portion of the top of the core active material, and a carbon nanostructure, such that high-rate characteristics and lifetime characteristics of lithium batteries may be improved.

It should be understood that the exemplary embodiments described herein should be considered in a descriptive sense only and not for purposes of limitation. Descriptions of features, advantages, or aspects within each embodiment shall be considered as available for other similar features, advantages, or aspects in other embodiments.

While one or more embodiments of the present disclosure have been described with reference to the figures, it will be understood by those of ordinary skill in the art that various changes in form and details may be made therein without departing from the spirit and scope of the present disclosure as defined by the following claims.

What is claimed is:

1. A composite cathode active material comprising:
a core comprising an active material; and
a coating film disposed on a surface of the core, the coating film comprising
a carbon nanostructure; and
a first polymer, wherein the first polymer is at least one selected from i) a fully fluorinated polymer and ii) a partially fluorinated polymer having a fluorine content of about 60 atomic percent to about 90 atomic percent, based on a total content of the partially fluorinated polymer.

2. The composite cathode active material of claim 1, wherein the first polymer is contained in an amount of about 10 parts by weight to about 700 parts by weight, based on 100 parts by weight of the carbon nanostructure.

3. The composite cathode active material of claim 1, wherein the first polymer and the carbon nanostructure are contained in an amount of about 0.1 part by weight to about 30 parts by weight, based on 100 parts by weight of the composite cathode active material.

4. The composite cathode active material of claim 1, wherein the first polymer comprises one or more selected from polytetrafluoroethylene, a perfluoroalkoxy polymer, poly(tetrafluoroethylene-hexafluoropropylene) copolymer, and a polytetrafluoroethylene-perfluoroalkyl methacrylic copolymer.

5. The composite cathode active material of claim 1, wherein the carbon nanostructure is one or more selected from a single-walled carbon nanotube and a multi-walled carbon nanotube.

6. The composite cathode active material of claim 1, wherein the first polymer and the composite cathode active material has a solubility of about 0.1 milligrams per milliliter or less with respect to an organic solvent.

7. The composite cathode active material of claim 1, wherein the coating film has a thickness of about 1 nanometer to about 200 nanometers.

8. The composite cathode active material of claim 1, wherein the active material of the core comprises one or more selected from an overlithiated layered oxide, a lithium manganese oxide, a lithium nickel manganese oxide, a lithium nickel manganese cobalt oxide, a lithium manganese oxide comprising a nonmetal element, a lithium nickel manganese oxide comprising a nonmetal element, and a lithium nickel manganese cobalt oxide comprising a nonmetal element.

9. The composite cathode active material of claim 1, wherein the active material of the core comprises a compound represented by Formula 1:
yLi[Li_{1/3}Me_{2/3}]O₂-(1-y)LiMe′O₂ Formula 1
wherein in Formula 1, 0<y<1, and Me is one or more selected from manganese (Mn), molybdenum (Mo), tungsten (W), vanadium (V), titanium (Ti), zirconium (Zr), ruthenium (Ru), rhodium (Rh), palladium (Pd), osmium (Os), iridium (Ir), and platinum (Pt), and Me′ is one or more selected from nickel (Ni), cobalt (Co), manganese (Mn), chromium (Cr), zirconium (Zr), niobium (Nb), copper (Cu), vanadium (V), titanium (Ti), zinc (Zn), aluminum (Al), gallium (Ga), magnesium (Mg), and boron (B).

10. The composite cathode active material of claim 9, wherein the Me in Formula 1 is represented by Formula 2:
M′ₐM_{b}Mn_{c} Formula 2
wherein, in Formula 2, M is one or more selected from molybdenum (Mo), tungsten (W), vanadium (V), titanium (Ti), zirconium (Zr), ruthenium (Ru), rhodium (Rh), palladium (Pd), osmium (Os), iridium (Ir) and platinum (Pt),
M′ is one or more selected from nickel (Ni), copper (Cu), zinc (Zn), cobalt (Co), chromium (Cr), iron (Fe) and magnesium (Mg),
0≦a≦0.33, 0<b≦0.33, and a+b+c=1.

11. The composite cathode active material of claim 1, wherein the active material of the core is one or more selected from compounds represented by Formulas 3 to 6:
LiₓCo_{1-y-z}Ni_{y}M_{z}O₂₋ₐXₐ Formula 3
wherein, in Formula 3, 0.9≦x≦1.6, 0≦y≦1, 0≦z≦1 and 0≦a≦1,
X is one or more selected from oxygen (O), fluorine (F), sulfur (S) and phosphorous (P),
M is one or more selected from nickel (Ni), cobalt (Co), manganese (Mn), chromium (Cr), zirconium (Zr), niobium (Nb), copper (Cu), vanadium (V), titanium (Ti), zinc (Zn), aluminum (Al), gallium (Ga), magnesium (Mg), and boron (B),
LiₓMn_{2-y}M_{y}O₄₋ₐXₐ Formula 4
wherein, in Formula 4, 0.9≦x≦1.6, 0≦y≦1, 0≦z≦0.5 and 0≦a≦1,
X is one or more selected from oxygen (O), fluorine (F), sulfur (S) and phosphorous (P),
M is one or more selected from nickel (Ni), cobalt (Co), manganese (Mn), chromium (Cr), zirconium (Zr), niobium (Nb), copper (Cu), vanadium (V), titanium (Ti), zinc (Zn), aluminum (Al), gallium (Ga), magnesium (Mg), and boron (B),
MFePO₄ Formula 5
wherein, in Formula 5, M is one or more selected from nickel (Ni), cobalt (Co), manganese (Mn), chromium (Cr), zirconium (Zr), niobium (Nb), copper (Cu), vanadium (V), titanium (Ti), zinc (Zn), aluminum (Al), gallium (Ga), magnesium (Mg), and boron (B),
LiₓM^{a}_{y}M^{b}_{z}Po_{4-d}X_{d} Formula 6
wherein, in Formula 6, 0.9≦x≦1.1, 0<y≦1, 0≦z≦1, 1.9≦x+y+z≦2.1 and 0≦d≦0.2;
M^{a} is one or more selected from iron (Fe), manganese (Mn), nickel (Ni), and cobalt (Co);
M^{b} is one or more selected from magnesium (Mg), calcium (Ca), strontium (Sr), barium (Ba), titanium (Ti), zirconium (Zr), niobium (Nb), molybdenum (Mo), tungsten (W), zinc (Zn), aluminum (Al), silicon (Si), chromium (Cr), copper (Cu), vanadium (V), gallium (Ga), and boron (B); and
X is one or more selected from sulfur (S), and fluorine (F).

12. The composite cathode active material of claim 1, wherein the active material of the core is one or more selected from Li_{1.17}Ni_{0.17}CO_{0.1}Mn_{0.56}O₂, LiCoO₂, LiFePO₄, LiFe₁₋ₐMnₐPO₄ (0<a<1), LiNi_{0.5}Mn_{1.5}O₄, and LiMnPO₄.

13. The composite cathode active material of claim 1, wherein the coating film is in a form of a single film.

14. The composite cathode active material of claim 1, wherein the coating film comprises
a first coating film, which is formed on the surface of the core and comprises the first polymer, and
a second coating film, which is disposed on a surface of the first coating film and comprises a carbon nanostructure.

15. The composite cathode active material of claim 1, wherein the coating film comprises polytetrafluoroethylene and a carbon nanotube.

16. A method of preparing the composite cathode active material of claim 1, the method comprising:
forming a coating film on a surface of a core comprising an active material, wherein the coating film comprises
a carbon nanostructure, and
a first polymer, wherein the first polymer is at least one selected from i) a fully fluorinated polymer and ii) a partially fluorinated polymer having a fluorine content of about 60 atomic percent to about 90 atomic percent, based on a total content of the partially fluorinated polymer.

17. The method of claim 16, where the forming of the coating film is performed using a dry process.

18. The method of claim 17, where the dry process comprises one or more selected from a planetary ball mill process, a ball mill process, a hybridization process, and a mechanofusion process.

19. A cathode comprising the composite cathode active material according to claim 1.

20. Lithium battery comprising the cathode according to claim 19.
